(19) United States
(12) Patent Application Publication
(10) Pub. No.: US 2026/0009153 A1
(43) Pub. Date: Jan. 8, 2026

(54) Fabrication of Heat Exchangers with Variable Unit-Area Thermal Conductivities

(71) Applicant: Fabric8Labs, Inc., San Diego, CA (US)

(72) Inventors: Ian Winfield, Oceanside, CA (US); Joseph Madril, San Diego, CA (US); Timothy Ouradnik, San Diego, CA (US); Gautam Gupta, San Diego, CA (US); Charles Biset, San Diego, CA (US); Douglas Castro, San Diego, CA (US)

(21) Appl. No.: 19/251,552

(22) Filed: Jun. 26, 2025

Related U.S. Application Data
(60) Provisional application No. 63/667,120, filed on Jul. 2, 2024.
(60) Provisional application No. 63/694,053, filed on Sep. 12, 2024.
(60) Provisional application No. 63/695,162, filed on Sep. 16, 2024.
(60) Provisional application No. 63/696,759, filed on Sep. 19, 2024.
(60) Provisional application No. 63/697,403, filed on Sep. 20, 2024.
(60) Provisional application No. 63/697,993, filed on Sep. 23, 2024.
(60) Provisional application No. 63/725,483, filed on Nov. 26, 2024.

(51) Int. Cl. C25D 1/00; B33Y 10/00; B33Y 80/00; F28F 21/08

(52) U.S. Cl. CPC C25D 1/003; B33Y 10/00; B33Y 80/00; F28F 21/089

(57) ABSTRACT

A method of fabricating a heat exchanger using an electrochemical additive manufacturing (ECAM) system comprises determining a set of extension design features for the heat exchanger and electroplating the heat-exchanging extensions in accordance with the set of extension design features. The ECAM system comprises a build plate and a printhead. The heat exchanger comprises a heat-receiving surface for thermal coupling to a heat source and heat-exchanging extensions forming openings for circulating a heat transfer fluid through the heat exchanger. The determining operation is performed based on at least a thermal map of the heat source. The heat-exchanging extensions are designed such that a unit-volume material to space ratio between the heat-exchanging extensions and the openings is different for at least two different portions of the heat-receiving surface during operation of the heat exchanger.

### CROSS-REFERENCE TO RELATED APPLICATIONS

This application claims the benefit under 35 U.S.C. § 119 (e) of U.S. Provisional Patent Application 63/694,053 filed on 2024 Sep. 12 and also claims the benefit under 35 U.S.C. § 119 (e) of U.S. Provisional Patent Application 63/697,993 filed on 2024 Sep. 23, U.S. Provisional Patent Application 63/667,120 filed on 2024 Jul. 2, US Provisional Patent Application 63/725,483 filed on 2024 Nov. 26, U.S. Provisional Patent Application 63/695,162, filed on 2024 Sep. 16, U.S. Provisional Patent Application 63/696,759, filed on 2024 Sep. 19, and U.S. Provisional Patent Application 63/697,403, filed on 2024 Sep. 20, all of which are incorporated herein by reference in their entirety for all purposes.

### BACKGROUND

Fluid cooling for electronics (e.g., in data centers) and other applications may be categorized based on the coolant's interaction with heat sources: direct (when the coolant comes in direct contact) and indirect (using intermediary heat exchangers, such as a cold plate, heat pipe, or vapor chamber, to transfer heat from the processor to the coolant). Indirect cooling avoids direct contact between the coolant and electronics, which makes it more attractive for various applications.

### SUMMARY

A method of fabricating a heat exchanger using an electrochemical additive manufacturing (ECAM) system comprises determining a set of extension design features for the heat exchanger and electroplating the heat-exchanging extensions in accordance with the set of extension design features. The ECAM system comprises a build plate and a printhead. The heat exchanger comprises a heat-receiving surface for thermal coupling to a heat source and heat-exchanging extensions forming openings for circulating a heat transfer fluid through the heat exchanger. The determining operation is performed based on at least a thermal map of the heat source. The heat-exchanging extensions are designed such that a unit-volume material to space ratio between the heat-exchanging extensions and the openings is different for at least two different portions of the heat-receiving surface during operation of the heat exchanger.
Clause 1. A heat exchanger for use on a heat source comprising a heat-transferring surface, the heat exchanger comprising: a base comprising a heat-receiving surface for thermal coupling to the heat-transferring surface; and a heat-exchanging portion electrochemically deposited on and attached to the base and comprising heat-exchanging extensions, wherein: the heat-exchanging extensions comprise heat-exchanging surfaces extending to the base, a combination of the heat-exchanging surfaces and the base forms openings for circulating a heat transfer fluid through the heat exchanger, the openings such that the heat transfer fluid directly interfaces the heat-exchanging surfaces while circulating through the heat exchanger, and the heat-exchanging extensions are electrochemically deposited such that a unit-volume material to space ratio between the heat-exchanging extensions and the openings is different for at least two different portions of the heat-receiving surface.
Clause 2. The heat exchanger of clause 1, wherein the heat-exchanging surfaces of the heat-exchanging extensions have a height (H) that is different at different parts of the heat-receiving surface.
Clause 3. The heat exchanger of clause 2, wherein: the heat exchanger comprises a heat exchanger inlet and a heat exchanger outlet, the heat exchanger inlet is configured to receive the heat transfer fluid into the heat exchanger, the heat exchanger outlet is configured to discharge the heat transfer fluid from the heat exchanger, and the height (H) increases along a pathway of the heat transfer fluid from the heat exchanger inlet to the heat exchanger outlet.
Clause 4. The heat exchanger of clause 1, wherein: the heat-exchanging extensions are continuous fins having a thickness (T) defined by the heat-exchanging surfaces and two adjacent ones of the openings, the thickness (T) is different at different parts of the heat-receiving surface.
Clause 5. The heat exchanger of clause 4, wherein: the heat exchanger comprises a heat exchanger inlet and a heat exchanger outlet, the heat exchanger inlet is configured to receive the heat transfer fluid into the heat exchanger, the heat exchanger outlet is configured to discharge the heat transfer fluid from the heat exchanger, and the thickness (T) changes along or perpendicular to a pathway of the heat transfer fluid from the heat exchanger inlet to the heat exchanger outlet.
Clause 6. The heat exchanger of clause 1, wherein: the openings have an opening width (Wo), defined as an average space between any two closest pairs of the heat-exchanging surfaces, the opening width (Wo) is different at different parts of the heat-receiving surface.
Clause 7. The heat exchanger of clause 6, wherein: the heat exchanger comprises a heat exchanger inlet and a heat exchanger outlet, the heat exchanger inlet is configured to receive the heat transfer fluid into the heat exchanger, the heat exchanger outlet is configured to discharge the heat transfer fluid from the heat exchanger, and the opening width (Wo) decreases along a pathway of the heat transfer fluid from the heat exchanger inlet to the heat exchanger outlet.
Clause 8. The heat exchanger of clause 1, wherein: the heat-exchanging extensions are individual disjoined structures, extending perpendicular to the base, each of the heat-exchanging extensions has a largest cross-sectional dimension different at different parts of the heat-receiving surface.
Clause 9. The heat exchanger of clause 1, wherein: the heat-exchanging extensions are individual disjoined structures, extending perpendicular to the base, each of the heat-exchanging extensions has a cross-sectional shape that is different at different parts of the heat-receiving surface.
Clause 10. The heat exchanger of clause 1, wherein a cross-sectional shape is selected from the group consisting of a circle, an oval, a square, and a triangle.
Clause 11. The heat exchanger of clause 1, wherein material composition of the heat-exchanging extensions differs at different parts of the heat-receiving surface.
Clause 12. The heat exchanger of clause 1, wherein: the heat-exchanging surfaces of the heat-exchanging extensions have a height (H), and material composition of the heat-exchanging extensions differs along the height (H).
Clause 13. The heat exchanger of clause 1, wherein the base and the heat-exchanging portion have different compositions.
Clause 14. The heat exchanger of clause 13, wherein: the base is formed from tungsten; and the heat-exchanging portion is formed from copper.
Clause 15. The heat exchanger of clause 1, wherein the heat transfer extensions have a height (H) of 30-200 micrometers.
Clause 16. The heat exchanger of clause 1, wherein the heat transfer extensions have a thickness (T) of 30-200 micrometers.
Clause 17. The heat exchanger of clause 1, wherein the heat transfer extensions have an average pitch (P) of 50-250 micrometers.
Clause 18. The heat exchanger of clause 1, wherein: the base comprises a base surface extending into and forming a bottom of the openings, and the base surface is non-planar.
Clause 19. The heat exchanger of clause 18, wherein the base surface comprises a set of base-surface protrusions, each having a shape selected from the group consisting of a cylinder, a pyramid, a hemispherical dimple, a trapezoidal rib, a sinusoid, and a square wave.
Clause 20. The heat exchanger of clause 19, wherein the set of base-surface protrusions define a pitch between two adjacent ones in the set of base-surface protrusions such that the pitch varies along or perpendicular to a pathway of the heat transfer.
Clause 21. The heat exchanger of clause 1, wherein a surface area of the heat-exchanging surfaces of the heat-exchanging extensions, per unit area of the heat-receiving surface, changes along or perpendicular to a pathway of the heat transfer.
Clause 22. The heat exchanger of clause 1, wherein the heat-exchanging surfaces of the heat-exchanging extensions comprise sidewall protrusions extending to adjacent one of the heat-exchanging surfaces.
Clause 23. The heat exchanger of clause 1, wherein the heat-exchanging surfaces have a shape selected from the group consisting of a triangle, and a sinusoid.
Clause 24. The heat exchanger of clause 1, further comprising a cover, wherein the cover is sealably coupled to the forming a cavity such that the openings are parts of the cavity.
Clause 25. The heat exchanger of clause 24, wherein the cover is spaced away from the heat-exchanging extensions forming a cover spacing that is a part of the cavity.
Clause 26. The heat exchanger of clause 24, wherein the cover directly interfaces the heat-exchanging extensions.
Clause 27. The heat exchanger of clause 1, wherein the heat-exchanging portion and the base are formed from different materials.
Clause 28. The heat exchanger of clause 1, wherein the openings have a total combined volume of less than 100 milliliters.
Clause 29. The heat exchanger of clause 1, wherein the heat source is selected from the group consisting of a central processing unit (CPU), a graphical processing unit (GPU), an application-specific integrated circuit (ASIC), a field-programmable gate array (FPGA), a chipset, a power amplifier, a memory module, and a power management integrated circuit (IC).
Clause 30. The heat exchanger of clause 1, further comprising a cover sealed against the base and forming a cavity thereby between, wherein the heat-exchanging portion extends within the cavity such that the space is part of the cavity.
Clause 31. A heat source assembly comprising: a heat source comprising a heat-transferring surface; and a heat exchanger comprising a base and a heat-exchanging portion, wherein: the base comprising a heat-receiving surface mechanically adhered to the heat-transferring surface, the heat-exchanging portion is electrochemically deposited on and attached to the base and comprises heat-exchanging extensions, the heat-exchanging extensions comprise heat-exchanging surfaces extending to the base, a combination of the heat-exchanging surfaces and the base forms openings for circulating a heat transfer fluid through the heat exchanger, the openings extend to the base such that the heat transfer fluid directly interfaces the base and the heat-exchanging surfaces while circulating through the heat exchanger, and the heat-exchanging extensions are electrochemically deposited such that a unit-volume material to space ratio between the heat-exchanging extensions and the openings is different for at least two different portions of the heat-receiving surface.
Clause 32. The heat source assembly of clause 31, further comprising a thermal interface material positioned between the base and the heat source and comprising one or more materials selected from the group consisting of silver epoxy and solder.
Clause 33. The heat source assembly of clause 31, wherein the heat source is selected from the group consisting of a central processing unit (CPU), a graphical processing unit (GPU), an application-specific integrated circuit (ASIC), a field-programmable gate array (FPGA), a chipset, a power amplifier, a memory module, and a power management integrated circuit (IC).
Clause 34. A method of fabricating a heat exchanger using an ECAM system comprising a build plate and a printhead, the heat exchanger comprising a heat-receiving surface for thermal coupling to a heat source, the heat exchanger further comprising heat-exchanging extensions forming openings for circulating a heat transfer fluid through the heat exchanger, the method comprising: determining a set of extension design features of the heat-exchanging extensions based on at least a thermal map of the heat source, wherein the heat-exchanging extensions are designed such that a unit-volume material to space ratio between the heat-exchanging extensions and the openings is different for at least two different portions of the heat-receiving surface during operation of the heat exchanger; and electroplating the heat-exchanging extensions on the build plate in accordance with the set of extension design features, wherein: the printhead comprises a set of pixelated electrodes and electrode-array drivers, each controlling current through a corresponding electrode in the set of pixelated electrodes while electroplating the heat-exchanging extensions, and controlling the current determines locations of the heat-exchanging extensions on the build plate.
Clause 35. The method of clause 34, wherein determining a set of extension design features comprises determining a target level of the unit-volume material to space ratio between the heat-exchanging extensions and the openings.
Clause 36. The method of clause 35, wherein the set of extension design features varies for different parts of the heat-receiving surface.
Clause 37. The method of clause 34, wherein the thermal map of the heat source comprises a first temperature zone and a second temperature zone having a different temperature than the first temperature zone.
Clause 38. The method of clause 37, wherein the set of extension design features corresponding to the first temperature zone is different from the set of extension design features corresponding to the second temperature zone.
Clause 39. The method of clause 34, wherein the set of extension design features is further determined based on or more flow characteristics of the heat transfer fluid selected from the group consisting of a volumetric flow rate, an initial fluid temperature, one or more fluid thermal characteristics, and one or more fluid dynamic characteristics.
Clause 40. The method of clause 34, wherein the set of extension design features is selected from the group consisting of extension shape, extension size, extension density, extension material, and extension flow disruptor design.
Clause 41. The method of clause 34, wherein the build plate is a part of the heat source such that the heat-exchanging extensions are electrochemically deposited on and attached to the heat source.
Clause 42. The method of clause 34, further comprising, prior to electroplating the heat-exchanging extensions, forming a seed layer on the heat source.
Clause 43. The method of clause 34, wherein: the heat exchanger further comprises a base comprising a heat-receiving surface for thermal coupling to the heat source; and the build plate is a part of the base such that the heat-exchanging extensions are electrochemically deposited on and attached to the base.
Clause 44. The method of clause 43, further comprising, prior to electroplating the heat-exchanging extensions, electroplating the base on the build plate.
Clause 45. The method of clause 44, further comprising, prior to electroplating the base, determining a set of base design features based on at least a thermal map of the heat source.
Clause 46. The method of clause 45, wherein the set of base design features is selected from the group consisting of base shape, base size, base material, and base flow disruptors.
Clause 47. The method of clause 43, wherein: the heat-exchanging extensions comprise heat-exchanging surfaces extending to the base, a combination of the heat-exchanging surfaces and the base forms the openings for circulating a heat transfer fluid through the heat exchanger, and the openings extend to the base such that the heat transfer fluid directly interfaces the base and the heat-exchanging surfaces while circulating through the heat exchanger.
Clause 48. The method of clause 34, further comprising attaching the heat exchanger to the heat source.
Clause 49. The method of clause 34, wherein attaching the heat exchanger to the heat source comprises positioning a thermal interface materials (TIM) between the heat-receiving surface and the heat source.
Clause 50. The method of clause 34, wherein the heat source is selected from the group consisting of a central processing unit (CPU), a graphical processing unit (GPU), an application-specific integrated circuit (ASIC), a field-programmable gate array (FPGA), a chipset, a power amplifier, a memory module, and a power management integrated circuit (IC).
Clause 51. The method of clause 34, wherein the heat-exchanging surfaces of the heat-exchanging extensions have a height (H) that is different at different parts of the heat-receiving surface.
Clause 52. The method of clause 51, wherein: the heat exchanger comprises a heat exchanger inlet and a heat exchanger outlet, the heat exchanger inlet is configured to receive the heat transfer fluid into the heat exchanger, the heat exchanger outlet is configured to discharge the heat transfer fluid from the heat exchanger, and the height (H) increases along a pathway of the heat transfer fluid from the heat exchanger inlet to the heat exchanger outlet.
Clause 53. The method of clause 34, wherein: the heat-exchanging extensions are continuous fins having a thickness (T) defined by the heat-exchanging surfaces and two adjacent ones of the openings, the thickness (T) is different at different parts of the heat-receiving surface.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, and methods. These drawings in no way limit any changes in form and detail that may be made by one skilled in the art without departing from the spirit and scope of the disclosed implementations.

FIG. 1A is a schematic cross-sectional view of a heat exchanger thermally coupled to a heat source and comprising a base, heat-exchanging extensions attached to the base, and a cover forming a cavity in which the heat-exchanging extensions are positioned and heat transfer fluid is contained, in accordance with some examples.

FIG. 1B is a schematic cross-sectional view of a portion of the heat exchanger in FIG. 1A, illustrating the arrangement of the base, heat-exchanging extensions, and a cover spaced away from the extensions, in accordance with some examples.

FIG. 1C is a schematic cross-sectional view of another example of the heat exchanger, in which the cover directly interfaces the heat-exchanging extensions.

FIG. 2A is a top cross-sectional view of a heat exchanger illustrating thermal fluid flow paths and heat transfer zones, in accordance with some examples.

FIG. 2B is a side cross-sectional view of the heat exchanger in FIG. 2A, illustrating the gradually changing height of the heat-exchanging extensions, in accordance with some examples.

FIG. 2D is a top cross-sectional view of a heat exchanger with a central delivery of the cooling fluid to heat-transfer zones having different designs of the heat-exchanging extensions and different unit-area thermal conductivities, in accordance with some examples.

FIG. 2E is a top cross-sectional view of a heat exchanger having multiple heat-transfer zones with varying thermal transfer characteristics defined by different widths and spacing of the heat-exchanging extensions, matched to localized hot zones of a heat source, in accordance with some examples.

FIG. 2F is a top cross-sectional view of a heat exchanger illustrating variations in the geometry of heat-exchanging extensions, including differing widths and spacings of the heat-exchanging extensions in different zones of the heat exchanger, in accordance with some examples.

FIG. 2G is a top view schematic of a heat exchanger illustrating heat-exchanging extensions in the form of cylindrical columns with different cross-sectional dimensions and densities corresponding to different temperature zones, in accordance with some examples.

FIG. 2H is a top cross-sectional view of a heat exchanger illustrating a combination of the heat-exchanging extensions and flow blockers for controlling the flow paths and flow rates inside the heat exchanger, in accordance with some examples.

FIG. 2I is a top view schematic of a heat exchanger illustrating heat-exchanging extensions variations in the geometry, including differing fin spacing (pitch) densities corresponding to different temperature/power zones, in accordance with some examples.

FIG. 3A is a schematic illustration of the base surface having a non-planar shape and extending within the channels formed by the heat-exchanging extensions, in accordance with some examples.

FIG. 3B is a schematic illustration of the base surface having a non-planar shape and heat-exchanging extensions having sidewall protrusions extending into the channels, in accordance with some examples.

FIG. 4 is a schematic view of a heat exchanger with a wave-profiled channel structure (e.g., a vertical serpentine), illustrating various aspects of the wall geometry along the flow direction, in accordance with some examples.

FIG. 5A is a process flowchart corresponding to a method for fabricating a heat exchanger using an ECAM system, in accordance with some examples.

FIG. 5B is a block diagram of various parameters used in the method of FIG. 5A, in accordance with some examples.

FIG. 5C illustrates an example of a thermal map with three temperature zones.

FIG. 5D illustrates the design of a heat exchanger determined/developed based on the thermal map in FIG. 5C.

FIG. 5E illustrates a temperature profile of the same heat-transferring surface after thermally coupling this heat-transferring surface to the heat exchanger.

FIGS. 5F-5I illustrate how different designs of heat exchangers produce different “with-exchanger thermal maps”.

FIG. 6A is a schematic illustration of an ECAM system for fabricating heat exchangers, in accordance with some examples.

FIG. 6B is the top view of a printhead comprising a set of pixelated electrodes, in accordance with some examples.

FIG. 6C is a schematic expanded view of a portion of the ECAM system (in FIG. 6A) illustrating electrolyte between the printhead and build plate, in accordance with some examples.

FIG. 6D is a schematic block diagram illustrating different components of the electrolyte, in accordance with some examples.

### DETAILED DESCRIPTION

### Introduction

Heat exchangers (e.g., heat sinks, cooling units) are conventionally manufactured using extrusion, stamping, die casting, bonding, folding, forging, skiving, and machining. However, these methods put various limitations on geometry, materials, and other design considerations. For example, a typical heat sink formed by skiving has a base and multiple parallel fins that are made from the same material (e.g., copper) as the base and form uniform microchannels. The uniform design of such heat exchangers makes them less suitable for advanced cooling applications, such as high-power integrated circuits. For example, a cooled surface may have “hot spots” caused by localized heat generation and require higher heat removal to make the surface temperature more uniform. Furthermore, as cooling fluid flows through a heat exchanger, the fluid gets hotter, which may result in a lower temperature gradient and a lower heat flux in the downstream parts of the heat exchanger (with the uniform design of the heat transfer features throughout the heat exchanger). Finally, straight cooling fins as well as serpentine cooling structures, which are common in conventional heat exchangers (e.g., fabricated by skiving) can result in cooling fluids forming laminar flow conditions/boundary layer along these fins, which reduces the heat transfer from the fins into the cooling liquid.

Efficient thermal management remains a critical challenge in high-performance electronic systems, especially as device power densities (and corresponding heat dissipation) continue to increase. Traditional heat exchangers, such as cold plates with uniform microchannel arrays (e.g., formed by skiving), often fail to adequately address spatially non-uniform heat generation, leading to local hot spots and inefficient thermal performance. Furthermore, such designs typically rely on planar channel architectures and uniform flow distribution, which limit the ability to modulate coolant velocity or induce impingement-based heat transfer enhancements.

Existing manufacturing techniques also impose constraints on the geometries and resolution achievable within microchannel heat exchangers. Mechanical machining and conventional lithography-based processes often struggle to produce complex, spatially varying channel geometries or integrated flow-disrupting features at the microscale, especially across large surface areas. These limitations hinder efforts to tailor thermal resistance profiles or fluid flow patterns to the localized cooling demands of heat-generating devices.

Electrochemical additive manufacturing (ECAM) provides various means of overcoming these design and fabrication constraints. Using ECAM, a heat-exchanging portion and, in some examples, a base may be fabricated with various geometric features, e.g., variable and/or non-uniform shapes, adding flow disruptors, and many others further described below. Specifically, a heat-exchanging portion comprises heat-exchanging extensions that form openings (e.g., channels and other types of openings) over the base or directly over the heat source. These heat-exchanging extensions may be electroplated onto the base or heat source and may be referred to as growth-rooted structures. The openings between these extensions are configured to allow heat-transfer fluid/coolant to circulate while directly interfacing the extensions (and the base/heat source), enabling efficient convective heat transfer from the base to the fluid.

Unlike conventional systems with uniform geometry, heat exchangers described herein include non-uniform structural features that may vary spatially to tune the local unit-area thermal conductivity and/or a unit-volume material to space ratio between the heat-exchanging extensions and the heat transfer fluid space (e.g., defined by the openings). In particular, the height, width, spacing, surface topology, and/or materials of heat-exchanging extensions may be varied along the coolant path to modulate flow velocity, re-impingement frequency, and surface area exposure. This set of extension design features may be developed based on thermal maps (e.g., the presence of “hot spots” and/or flow characteristics such as the initial fluid temperature and the inherent heating of the heat-transfer fluid as this fluid travels through the heat exchanger. Furthermore, when the base is present, the base surface (exposed within the openings formed by the heat-exchanging extensions) may have a non-planar shape, e.g., have triangular or sinusoidal profiles further enhancing mixing and disrupting the laminar flow. Similar non-planar features may be used on the sidewalls of the heat-exchanging extensions.

Such heat exchangers offer multiple performance advantages over conventional heat exchangers (e.g., using straight fins), including lower thermal resistance, improved coolant distribution, enhanced convective transfer, and greater spatial control of heat extraction. These benefits are achieved without the need for discrete assembly of complex internal structures, relying instead on additive fabrication strategies that yield fine-resolution, customizable cooling geometries. In some examples, multiple flow domains and manifold inlet/outlet systems further improve coolant path efficiency and adaptability.

### Examples of Heat Exchangers

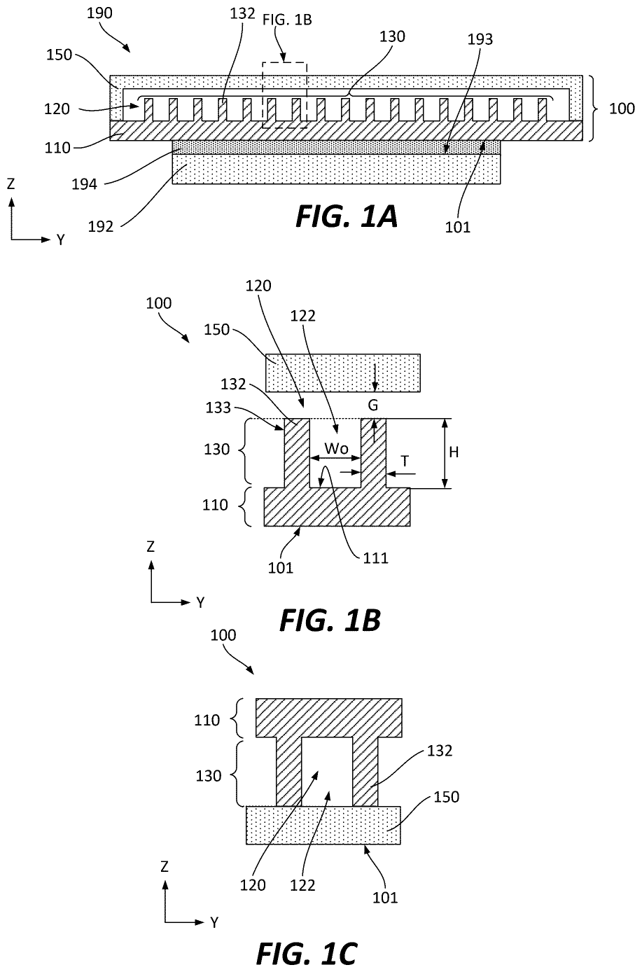

FIG. 1A is a schematic cross-sectional view of a heat exchanger 100 thermally coupled to a heat source 192 and comprising a base 110 and heat-exchanging extensions 132 attached to the base 110 and forming a heat-exchanging portion 130, in accordance with some examples. A combination of a heat exchanger 100 and a heat source 192 may be referred to as a heat source assembly 190. In some examples, the heat source assembly 190 also comprises other components, e.g., a thermal interface material 194.

Specifically, the heat source 192 comprises a heat-transferring surface 193 to which the heat exchanger 100 is attached to, e.g., directly or using an optional thermal interface material 194. The optional thermal interface material 194 may be formed from a thermal interface material (TIM). Various examples of heat sources 192 are within the scope, e.g., a central processing unit (CPU), a graphical processing unit (GPU), an application-specific integrated circuit (ASIC), a field-programmable gate array (FPGA), a chipset, a power amplifier, a memory module, and a power management integrated circuit (IC).

It should be noted that base 110 is optional and, in some examples, the heat-exchanging extensions 132 may be formed directly on the heat-transferring surface 193, i.e., the heat-receiving surface 101 and heat-transferring surface 193 may coincide. This configuration may be referred to as “direct-to-die” and allows for the heat-transfer fluid to form direct contact with the heat-transferring surface 193.

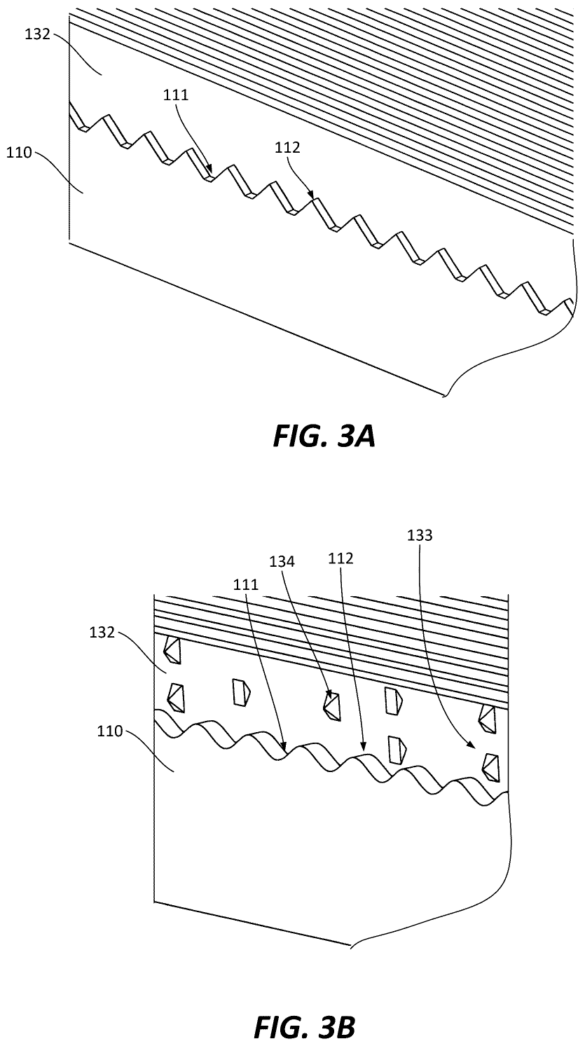

Referring to FIG. 1A, in some examples, the heat exchanger 100 may also comprise a cover 150, e.g., sealably coupled to the base 110 (or the heat source 192) and forming a cavity 120. The cavity 120 may be used for circulating and containing the heat-transfer fluid (e.g., liquids, gases, mixtures of liquids and gases, etc.). For purposes of this disclosure, the terms “heat-transfer fluid” and “cooling fluid” are used interchangeably. However, the heat exchanger 100 may be used for both cooling and heating of the heat source 192. The fluid flows within the cavity 120 (from the fluid inlet to the fluid outlet) while absorbing heat from the heat-exchanging portion 130. Specifically, with reference to FIG. 1B, the heat transfer extensions 132 comprise heat-exchanging surfaces 133 that come in contact with the heat-transfer fluid. In some examples, the fluid also comes in direct contact with the base 110. Furthermore, the immersive cooling, in which the fluid comes in direct contact with the heat source 192 is also within the scope (e.g., the base 110 may have openings, or the heat exchanger 100 may not include a base as shown in FIG. 3A and described below).

In some examples, the heat-exchanging portion 130 may be attached to or, even, monolithic with the base 110, e.g., as shown in FIGS. 1A and 1B. For example, the heat-exchanging portion 130 is electrochemically deposited on and attached to the base 110 (e.g., is growth-rooted to the base 110). In other examples, (e.g., “direct-to-die”, the heat-exchanging portion 130 is electrochemically deposited on a heat source 192. Alternatively, the heat-exchanging portion 130 may be supported on (e.g., monolithic with) the cover 150, which may be referred to as a “reverse” configuration. It should be noted that even in this “reverse” configuration, the heat-exchanging portion 130 is thermally coupled to the base 110 (e.g., through direct contact or some intermediate structure). In some examples, a reverse heat exchanger may be attached to the heat source 192 with an edge seal (e.g. gasket, brazing, soldering, etc.) that effectuates adhesion between the heat source 192 and seals in any heat exchanging fluid. Additional design aspects are described below with reference to various figures.

Overall, the heat exchanger 100 comprises a heat-receiving surface 101 for thermal coupling to the heat-transferring surface 193. Referring to FIG. 1B, the heat-receiving surface 101 may be a part of the base 110. Alternatively, the heat-receiving surface 101 may be a part of the heat-exchanging portion 130 (e.g., in “direct-to-die”/“direct-to-heat-source” examples) or a part of the cover 150, e.g., as shown in FIG. 1C.

Referring to FIG. 1B, the heat-exchanging extensions 132 comprise heat-exchanging surfaces 133 extending to the base 110. The heat-exchanging surfaces 133 may be also referred to as sidewalls. A combination of the heat-exchanging surfaces 133 and, in some examples, the base 110 forms openings 122 for circulating a heat transfer fluid through the heat exchanger 100. These openings 122 are parts of the cavity 120 and extend to the base 110 (or to the heat-transferring surface 193 in the “direct to die” examples) such that the heat-transfer fluid directly interfaces with the base 110 (or to the heat-transferring surface 193) and the heat-exchanging surfaces 133 while circulating through the heat exchanger 100.

In some examples, the heat-exchanging portion 130 comprises a uniform material composition, e.g., along the height (H) of the heat-exchanging extensions 132. For example, the heat-exchanging extensions 132 may be formed entirely of copper, aluminum, tungsten, alloys, etc. Alternatively, the composition of the heat transfer extensions 132 varies along the height (H). This feature may be enabled by the ECAM process used to fabricate the heat exchanger 100 or, more specifically, to fabricate at least the heat-exchanging portion 130. For example, an electrolyte containing metal ions may be changed during the ECAM deposition. As such, different sub-layers used to form heat transfer extensions 132 may have different compositions.

In some examples, the heat-exchanging extensions 132 are designed and electrochemically deposited such that a unit-volume material to space ratio between the heat-exchanging extensions 132 and the heat transfer fluid space (defined by the openings 122) is different for at least two different portions of the heat-receiving surface 101. For purposes of this disclosure, the “unit-volume material to space ratio” is defined as a ratio of the volume of the heat-exchanging extensions 132 to the ratio of the volume occupied by the surrounding openings 122 for a unit volume of the interior (e.g., defined by the cavity 120) of the heat exchanger 100. In some examples, the unit-volume material to space ratio differs for at least two unit-volumes of the heat exchanger 100 by least 25%, at least 50%, or even at least 100%.

In some examples, the heat-exchanging extensions 132 are configured such that a unit-area thermal conductivity between the heat-receiving surface 101 and the heat transfer fluid is different for at least two different portions of the heat-receiving surface 101. The unit-area thermal conductivity is defined as the “k/l” ratio in the following heat flux formula:

$$Q = k \frac{Δ T \times A}{L}$$

It should be noted that for purposes of this disclosure, the above equation applied to the heat exchanger 100 as a whole, in which “A” represents the area of the heat-receiving surface 101. As such, the unit-area thermal conductivity (k/L) is a function of both materials used to form various components of the heat exchanger 100 (e.g., heat-exchanging extensions 132) and the geometry of these components (as further described below). Furthermore, the “unit-area” used in the unit-area thermal conductivity has to be sufficiently large to accommodate a representative set of features of the heat exchanger 100 (e.g., two of more adjacent heat-exchanging extensions 132 and two or more gaps between these heat-exchanging extensions 132). The unit-area thermal conductivity is an average value for this unit area. For example, the “unit area” may be viewed as at least 10% of the overall heat-receiving surface 101 or even 25% of the overall heat-receiving surface 101.

In some examples, the difference in the unit-area thermal conductivity for at least two different portions of the heat-receiving surface 101 is at least 25%, at least 50%, or even at least 100%. As noted above, this difference may be used to accommodate different heat flux requirements (e.g., when the thermal map has hot spots) and/or heating of the heat-transfer fluid as this fluid flows through the heat exchanger 100.

In some examples, the difference in the unit-area thermal conductivity is achieved entirely by differences in the geometry of the heat-exchanging extensions 132 (e.g., shape, size, spacing, etc.). In other examples, the difference in the unit-area thermal conductivity is achieved using a combination of the geometry and material variations.

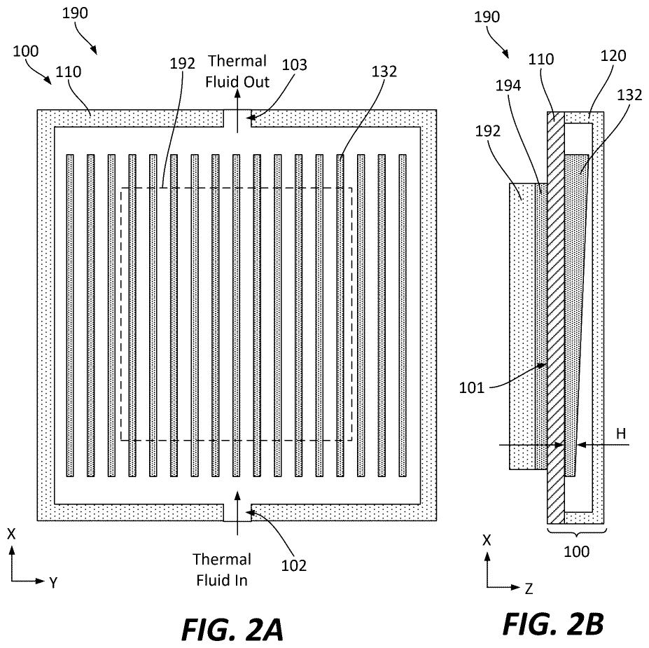

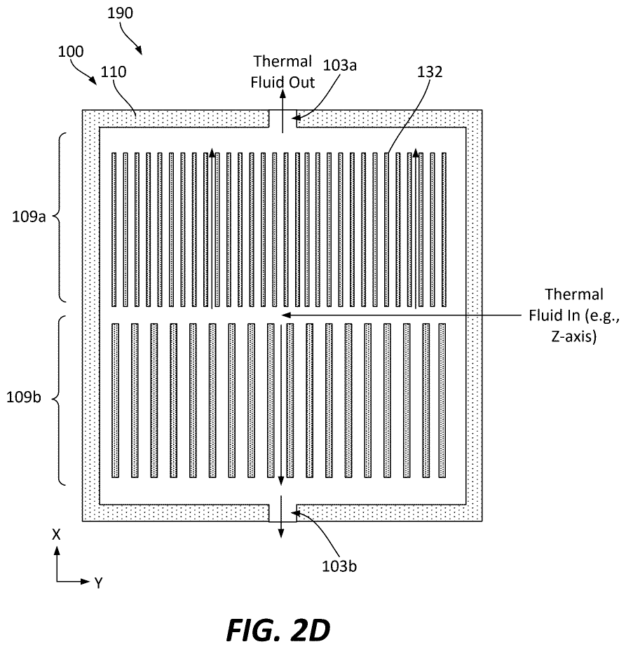

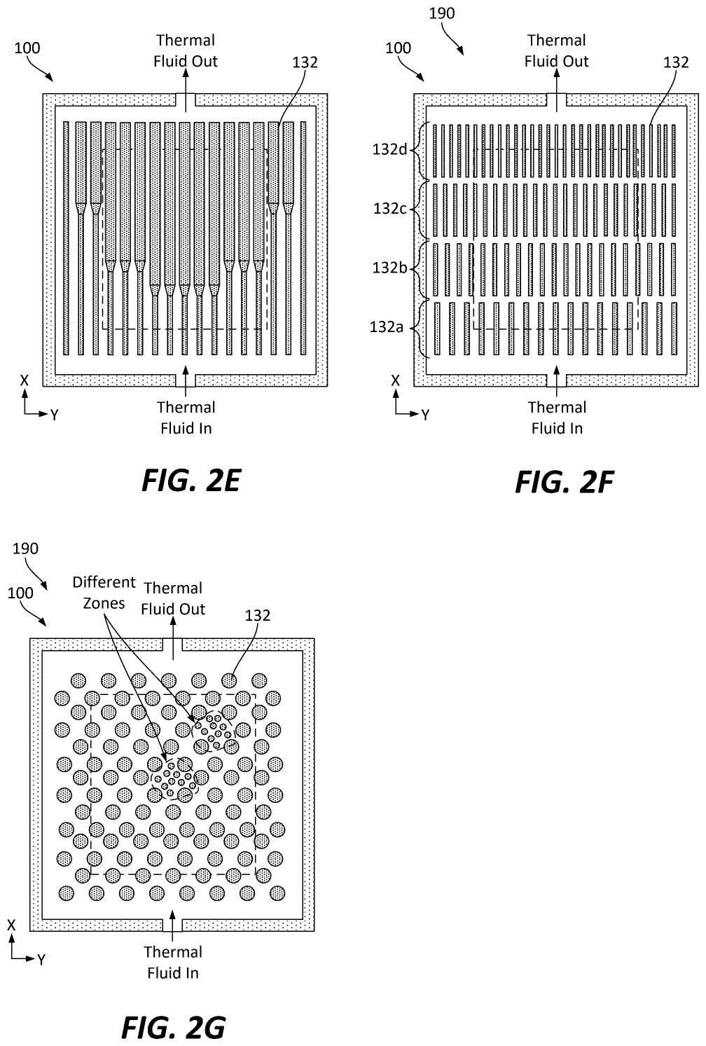

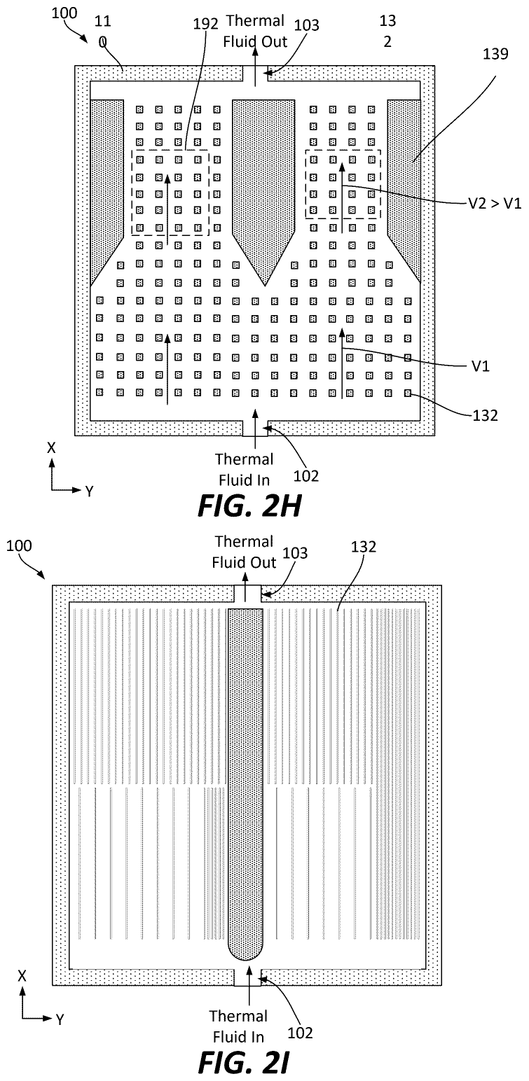

Referring to FIGS. 2A-2B, in some examples, the heat-exchanging surfaces 133 of the heat-exchanging extensions 132 have a height (H) that changes, e.g., increases along a pathway of the heat transfer fluid from the heat exchanger inlet 102 to the heat exchanger outlet 103. The height (H) is defined as a dimension that extends orthogonally to the heat-receiving surface 101 (e.g., along the Z-axis in FIG. 2B) and between base 110 and the uppermost edge of the heat-exchanging extensions 132. The height (H) determines the surface area of the heat-exchanging surfaces 133 that come in contact with the heat transfer fluid. Furthermore, the height (H) may determine the space available for the heat transfer fluid around the heat-exchanging surfaces 133, e.g., with less space corresponding to a higher linear flow of the heat transfer fluid (around the heat-exchanging surfaces 133) for the same volumetric flow rate. In specific examples, the increase in height (H) of the heat-exchanging surfaces 133 increases the effective heat flux, which may be needed, e.g., to accommodate various hot spots on the heat-transferring surface 193 and/or to compensate for the temperature increase of the heat transfer fluid as the heat transfer fluid flows through the heat exchanger 100.

In some examples, the height (H) of the heat-exchanging surfaces 133 changes gradually, e.g., as shown in FIGS. 2A-2B, such as gradually increasing from the inlet 102 to the outlet of the heat exchanger 100. This design may be used to compensate for the temperature increase of the heat transfer fluid as described above. Alternatively, the height (H) of the heat-exchanging surfaces 133 may change abruptly/in a step fashion. It should be noted that this height-variation feature may apply to the heat-exchanging surfaces 133 that span across multiple disjoined portions of the heat-exchanging extensions 132 (e.g., as schematically shown in FIG. 2E-2G).

FIG. 2D is a top cross-sectional view of a heat exchanger 100 with a central delivery of the cooling fluid illustrating thermal fluid flow paths and heat transfer zones, in accordance with some examples. In this example, heat exchanger 100 comprises two outlets, i.e., the first outlet 103a and second outlet 103b, with an inlet position between these outlets. The relative position of the inlet and both outlets may be used to define two separate heat transfer zones, i.e., a first heat transfer zone 109a and a second heat transfer zone 109b. The design of the first heat transfer zone 109a and a second heat transfer zone 109b may be the same or different (e.g., different size, geometry, and/or density of the heat-exchanging extensions 132, different sizes of the heat transfer zones), e.g., as shown in FIG. 2D. More generally, the unit-area thermal conductivity between the heat-receiving surface 101 and the heat transfer fluid may be different in the first heat transfer zone 109a and the second heat transfer zone 109b. For example, each heat transfer zone (with a dedicated outlet) may be specifically configured to accommodate different heat transfer requirements).

Referring to FIG. 2E, in some examples, the heat-exchanging extensions 132 have a thickness (T) that changes (e.g., increases) along a pathway of the heat transfer fluid from the heat exchanger inlet 102 to the heat exchanger outlet 103. A thicker extension provides better heat transfer/higher unit-area thermal conductivity than a thinner extension (in a one-to-one comparison) at least in the direction orthogonal to the heat-receiving surface 101 (i.e., in the direction along the height of the heat-exchanging extensions 132). For example, the heat-exchanging extensions 132 may get progressively thicker as the heat transfer fluid flows from the heat exchanger inlet 102 to the heat exchanger outlet 103. Furthermore, thicker heat-exchanging extensions 132 reduce the spacing between these extensions available for heat-transfer fluid thereby increasing the linear flowrate (for the same volumetric flowrate) and increasing the flow turbulence which may be beneficial for the overall heat transfer (reducing the boundary layers along the heat-exchanging surfaces 133).

However, it should be noted that thinner extensions allow for a higher extension density, i.e., a number of extensions per unit area, thereby increasing the total area of heat-exchanging surface 133 per unit area of the heat-receiving surface 101 as, e.g., schematically shown in FIG. 2F. Specifically, FIG. 2F is a top cross-sectional view illustrating variations in the geometry of heat-exchanging extensions 132, including differing fin widths and spacings in different zones of the heat exchanger 100, in accordance with some examples. This heat exchanger 100 has four zones 132a, 132b, 132c, and 132d, each having a different configuration of heat-exchanging extensions 132. The first zone 132a has the thickest heat-exchanging extensions 132 but also fewer heat-exchanging extensions 132 per unit area. The fourth zone 132d has the thinnest and most tightly packed heat-exchanging extensions 132.

Overall, widely spaced heat-exchanging extensions offer lower pressure drop, making them ideal for systems with limited pumping power or high-viscosity fluids. However, widely spaced heat-exchanging extensions also have a smaller overall heat-exchanging surface 133 per unit area of the heat-receiving surface 101 thereby limiting heat transfer efficiency. It should be noted that the selection of the thickness (T) and spacing(S) of the heat-exchanging extensions 132 may depend on the extension geometry, fluid properties, and flow regimes. For example, dense structures (e.g., fins) may cause some flow bypass if the spacing is too narrow (and alternative flow paths are available). On the other hand, widely spaced structures may create stagnant zones if the spacing is excessive. Low-conductivity fluids (e.g., air) may benefit from the high surface area of dense structures, while viscous fluids (e.g., liquids) may benefit from low-pressure drop/convective heat transfer that may form among the widely spaced structures.

In some examples, the surface area of the heat-exchanging surfaces 133 of the heat-exchanging extensions 132, per unit area of the heat-receiving surface 101, changes (e.g., increases) along a pathway of the heat transfer fluid from the heat exchanger inlet 102 to the heat exchanger outlet 103. As noted above, this change in the surface area may be achieved by changing the dimensions (e.g., height), density, shape (e.g., straight wall, separate structures), and/or other attributes of the heat-exchanging extensions 132. The increase in the surface area generally improves the unit-area thermal conductivity (assuming other conditions are the same). For example, the surface area of the heat-exchanging surfaces 133 (per unit area of the heat-receiving surface 101) may be 25% greater in one unit area of the heat-receiving surface 101 than in the other unit area, or 50% greater, or even 100% greater.

Referring to FIG. 2E, in some examples, a heat exchanger 100 comprises converging heat-exchanging extensions 132, forming “nozzles” within the openings 122 for accelerating the heat-transfer fluid within these openings 122 (e.g., to increase turbulence). Specifically, the spacing between two adjacent heat-exchanging extensions 132 may change by at least 25%, at least 50%, or even at least 75% from one unit area of the heat-receiving surface 101 to another unit area. In some examples, the spacing is less than 5 millimeters, less than 2 millimeters, less than 1 millimeter, or less than 0.5 millimeters.

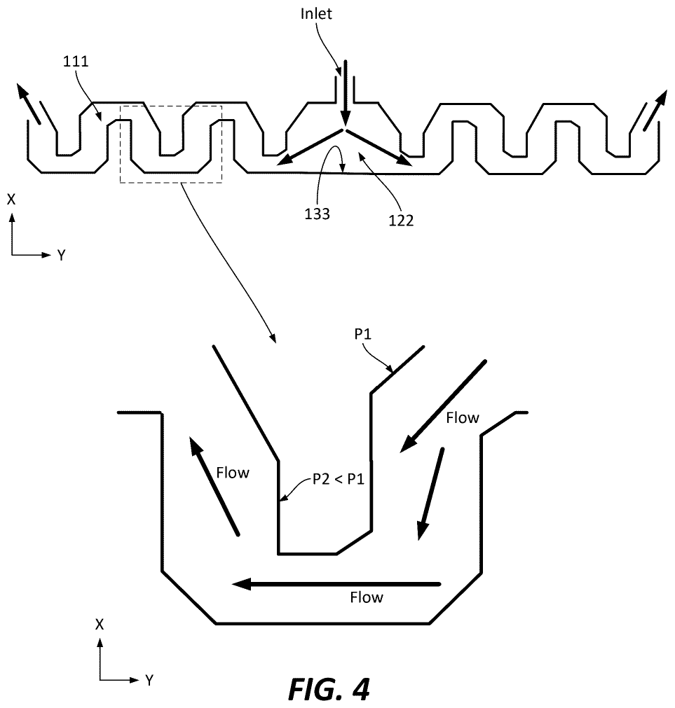

The features of heat-exchanging extensions 132 may be viewed from the perspective of openings 122. For example, openings 122 may be uniform (e.g., have the same width and height along the flow direction—e.g., X-axis in FIG. 1B) and/or straight (also along the flow direction). Alternatively, openings 122 may be non-uniform (e.g., become narrower as shown in FIGS. 2E and 2F), formed by non-continuous structures (e.g., as shown in FIGS. 2F and 2G), and/or not straight (e.g., as shown in FIG. 4). These features are possible when ECAM are used to fabricate at least heat-exchanging extensions 132. Furthermore, ECAM also may be used to fabricate various “flow disruptors,” e.g., components extending from the base 110, heat-exchanging surfaces 133, and/or cover 150 into the openings 122 to increase the flow turbulence thereby improving the thermal transfer to the cooling fluid.

Referring to FIG. 2G, in some examples, heat-exchanging extensions 132 may be non-continuous structures, e.g., cylindrical columns. Other cross-sectional shapes (within the plane parallel to the heat-receiving surface 101 are also within the scope), e.g., rectangular, square, triangular, and oval. In some examples, the aspect ratio of these cross-sectional shapes is less than 10, less than 5, or even less than 2 (to differentiate columns from continuous finds). The cross-sectional shapes and/or of these non-continuous structures may be the same throughout the heat-receiving surface 101 or different (e.g., as shown in FIG. 2G). For example, smaller/denser columns (that may have a higher unit-area thermal conductivity) may be positioned at the “hot zones/spots” (collective referred to different zones) of the thermal maps. It should be noted that in addition to the size and density of these columns, various other factors impact the heat transfer rates (e.g., flow rates and characteristics of the heat transfer fluid, geometry of the columns, etc.)

FIG. 2H is a top cross-sectional view of a heat exchanger 100 illustrating a combination of the heat-exchanging extensions 132 and flow blockers 139 for controlling the flow paths and flow rates inside the heat exchanger 100, in accordance with some examples. Flow blockers 139 may be also viewed as heat-exchanging extensions 132 (e.g., much larger versions of heat-exchanging extensions 132).

In some examples, heat-exchanging extensions 132 are porous structures allowing heat-transfer fluid to pass through the heat-exchanging extensions 132. These features may be used to increase the heat-exchanging surfaces 133 and to direct the flow without the heat exchanger 100. For example, the heat-exchanging extensions 132 may have openings that direct the flow in one or more directions that are not parallel to the heat-receiving surface 101.

Referring to FIG. 2I, a heat exchanger 100 may comprise heat-exchanging extensions 132 that have variations in the geometry, including differing fin spacing (pitch) densities corresponding to different temperature/power zones. This variability can help to guide the flow (e.g., more dense fin areas create a higher-pressure region and can help guide fluid flow to other areas such as where hotspots are expected/observed). Additionally, varying the pitch going from a less dense fin spacing region to a more dense fin spacing region produces a nozzle-like effect to help accelerate the fluid and increase fluid velocity and therefore increase cooling in said region. This design strategy also helps manage pressure drop. For example, if a small fin pitch is used throughout the heat exchanger a faster fluid velocity is achieve but this heat exchanger will also have a higher pressure drop.

Referring to FIGS. 3A and 3B, in some examples, the base 110 comprises a base surface 111 extending into and forming a bottom of opening 122. The base surface 111 is non-planar. When a heat transfer fluid flows over a planar (flat) surface, heat transfer relies on boundary layer conduction and convection. The thermal performance is governed by factors like boundary layer thickness, flow regime (laminar or turbulent), and fluid properties. In laminar flow, heat transfer is limited by the thick thermal boundary layer, while turbulent flow enhances mixing and improves convection. Non-planar surfaces (e.g., wavy surfaces, surfaces comprising protrusions and recesses (e.g., fins, dimples, or ribs) significantly improve heat transfer by increasing surface area and disrupting the boundary layer. These features promote turbulence, which enhances convective heat transfer, especially in low-velocity or viscous flows associated with minimal mixing. For example, protrusions extending across the flow-direction generate vortexes improving the thermal coupling/effective heat flux.

Referring to FIGS. 3A and 3B, in some examples, the base surface 111 comprises a set of base-surface protrusions 112, each having a shape selected from the group of a cylinder, a pyramid, a hemispherical dimple, a trapezoidal rib, a sinusoid, and a square wave. Different examples of base-surface protrusions 112 offer various thermal and fluid dynamic effects. Cylindrical pins can enhance turbulence and provide robust structural support. Pyramidal protrusions disrupt boundary layers effectively and shed vortices, improving heat transfer, but sharp edges can increase pressure drop. Sinusoidal surfaces (wavy fins), e.g., as shown in FIG. 3B, promote smooth, periodic mixing with moderate pressure drop. Square-wave profiles maximize flow disruption and surface area, boosting heat transfer significantly, but at the cost of high-pressure drop (similar to square pillars and pyramidal protrusions). A triangular wave surface, e.g., as shown in FIG. 3A composed of repeating sharp peaks and valleys, offers unique heat transfer advantages and drawbacks compared to smoother sinusoids or blocky square waves. The sharp peaks disrupt the boundary layer, creating intense turbulence and vortices that enhance convective heat transfer, particularly in high-velocity flows. Meanwhile, the angled slopes promote fluid acceleration, reducing stagnant zones compared to square waves. Hemispherical dimples enhance turbulence with minimal pressure penalty.

FIGS. 3A and 3B illustrate the base surface 111 of one channel/opening, while the base surfaces 111 of the other channel/opening are visually blocked (in these figures) by heat-exchanging extensions 132. The base surfaces 111 in all channels/openings may have the same profile or different profiles (e.g., different shapes, sizes, and density of the base-surface protrusions 112), e.g., to accommodate different heat transfer/flow requirements in different portions of the heat exchanger 100. ECAM techniques further described below enable these variations in heat-transfer features.

Referring to FIG. 3B, in some examples, the heat-exchanging surfaces 133 of the heat-exchanging extensions 132 comprise sidewall protrusions 134 extending to adjacent one of the heat-exchanging surfaces 133. The effect of these heat-exchanging extensions 132 is the same as base-surface protrusions 112. Furthermore, various examples of surface variations described above for the base surface 111 are also applicable to the heat-exchanging surfaces 133. Specifically, sidewall protrusions 134 disrupt the boundary layer (with the boundary layer limiting the heat transfer and taking heat). Base-surface protrusions 112 create turbulence and/or increase velocity of the flow thereby increasing heat transfer. For example, as the flow passes a protrusion, it creates a higher pressure zone that pushes the flow away from the surface, which is beneficial for convective heat transfer.

Overall, features like base-surface protrusions 112 and sidewall protrusions 134 may be referred to as flow disruptors to enhance the convective heat transfer within openings 122. Specifically, as heat-transfer fluid enters these openings 122 (e.g., channels), boundary layers may develop along the base surface 111 and/or the heat-exchanging surfaces 133. These boundary layers limit convective heat transfer within the openings 122 (from these surfaces to the fluid). Flow disruptors can cause re-initialization of boundary layers, which allows for enhanced heat transfer capability. ECAM techniques further described below enable the incorporation of these features during the fabrication of the base 110 and/or the heat-exchanging portion 130. In some examples, the set of base-surface protrusions 112 define a pitch between two adjacent ones in the set of base-surface protrusions 112 such that the pitch may vary along or perpendicular to a pathway of the heat transfer fluid. Similarly, the pitch defined by the sidewall protrusions 134 may vary along or perpendicular to a pathway of the heat transfer fluid.

Referring to FIG. 4, in some examples, the heat-exchanging surfaces 133 of the heat-exchanging extensions 132 are non-planar. For example, the heat-exchanging surfaces 133 may form a non-linear opening (e.g., a channel) having a shape selected from the group of sinusoids, triangular waves, square waves, and like. Portions of the heat-exchanging surfaces 133 may gradually transition between convex and concave zones. In some examples (e.g., FIG. 4), portions of the heat-exchanging surfaces 133 may be straight and form angles that vary along the flow direction. Overall, the non-planar feature/the non-linear opening formed by the heat-exchanging surfaces 133 helps to establish different pressure zones within the openings 122 such that the cooling fluid accelerates from high-pressure zones to low-pressure zones causing fluid intermixing inside the openings 122 thereby enhancing the heat transfer between the heat-exchanging surfaces 133 and the fluid by breaking up the laminar flow.

Overall, a serpentine fluidic path creates re-impingement zones to locally modulate velocity and enhance the mixing of the heat-transfer fluid. Flow impingement happens when fluid flows into a surface, which can concentrate the flow and facilitate the transfer of heat from the surface to the fluid. For cold plates, it is desirable to take advantage of impingement heat transfer while also preserving mass flow rate and fluid velocity, through the introduction of features that drive repeated and targeted fluid impingement onto the surface of the cold plate. Referring to FIG. 4, flow enters from the top center and then splits both left and right, with serpentine channel portions on both sides. In some examples, channels have both serpentine and straight portions. This can selectively target high-heat areas with re-impingement.

Referring to FIG. 1B, in some examples, ECAM may be to fabricate heat-exchanging extensions 132 that are particularly thin and/or spaced closely together. For example, the thickness (T) of each extension may be less than 200 micrometers, less than 100 micrometers, or even less than 70 micrometers. As a reference, the height (H) of the heat-exchanging extensions 132 may be at least 300 micrometers or even at least 5 millimeters. As such, a height-to-thickness (H/T) ratio may be at least 4, at least 10, at least 50, or even at least 80. Furthermore, the opening width (Wo), between two adjacent heat-exchanging extensions 132 may be less than 200 micrometers, less than 100 micrometers, or even less than 70 micrometers.

In some examples, the heat-exchanging portion 130 and the base 110 are formed from different materials e.g., the base 110 is made from tungsten, while the heat-exchanging portion 130 is made from copper. The lower CTE mismatch (than in the example of FIG. 1C) may allow a much thinner/more thermally conductive thermal interface material 194 (or no thermal interface material 194 at all) thereby improving the cooling of the heat source 192. The following table provides examples of different materials suitable for heat source 192, heat-exchanging portion 130, and base 110.

| | | Electrical | |
|---|---|---|---|
| | | Conductivity | |
| Material | CTE /° C. | (S/m) | Applications |
| Silicon (undoped) | 2.6 × 10⁻⁶ | 1-10 × 10⁻³ | heat source (e.g, CPU, GPU) |
| Copper | 16.5 × 10⁻⁶ | ~5.96 × 10⁷ | heat-exchanging portion |
| Tungsten | 4.5 × 10⁻⁶ | ~1.79 × 10⁷ | base |
| Cu (90%)—W (10%) | 8.3 × 10⁻⁶ | ~5.0 × 10⁷ | base |
| Cu (70%)—W (30%) | 7.2 × 10⁻⁶ | ~3.8 × 10⁷ | base |
| Cu (50%)—W (50%) | 6.0 × 10⁻⁶ | ~ 2.5 × 10⁷ | base |
| Silicon Nitride | 2.5-3.5 × 10⁻⁶ | ~10⁻¹⁴ to 10⁻¹⁶ | heat source |
| (Si₃N₄) | | | |
| Silicon Carbide (SiC) | 3.7-4.5 × 10⁻⁶ | ~10⁴ to 10⁵ | base |
| Silver-Diamond | 6-8 × 10⁻⁶ | ~4.0-5.5 × 10⁷ | base/thermal interface |
| Composite (AgD) | | | |
| Copper-Diamond | 6-9 × 10⁻⁶ | ~3.5-5.0 × 10⁷ | base/thermal interface |
| Composite (CuD) | | | |

Various examples of a heat-exchanging portion 130 are within the scope. For example, a heat-exchanging portion 130 may be formed by two composite microchannel structures, which are stacked, in which these microchannel structures have different pitches, and in which microchannels extend perpendicular to other structures. The composite aspect may be related to the material composition and/or types of structures in different parts of the heat-exchanging portion 130 (e.g., unlike conventional structures formed by skiving). For example, these structural differences may be used to support two or more different/independent flow paths within the heat-exchanging portion 130 (with heat transferred from one fluid path/fluid to another). The total height of this stack/heat-exchanging portion 130 may be between 0.3-2 millimeters or, more specifically, 0.4-1 millimeters.

In another example, a heat-exchanging portion 130 is formed by interwoven composite wicks, which provide precise alignment between meshes and metallurgical bonds between these meshes. Such heat-exchanging portions 130 may be used for two-phase cooling, especially in vapor chamber or wicking applications where capillary action is beneficial. Such heat-exchanging portions 130 provide many nucleation sites and paths for bubbles to escape. Specifically, bubbles operate as thermal insulators, and when the bubbles get trapped, the heat transfer rate is reduced, which is not desirable.

Another example of a heat-exchanging portion 130 is a composite gyroid, which provides a high-surface-area-to-volume ratio and may be referred to as a triply periodic minimal surface (TPMS) structure. Such TPMS structures are mathematically defined surfaces that repeat periodically in three dimensions and have zero mean curvature at every point. These structures provide excellent mechanical strength, low density, and high surface-area-to-volume ratio. Some notable characteristics include a mean curvature that is zero, meaning the surface is balanced in terms of tension. The structure repeats in three-dimensional space, forming a continuous and interconnected network. A high strength-to-weight ratio and a high-surface-area feature are useful for heat exchanger applications. Some examples of TPMS structures include but are not limited to, gyroid (e.g., a highly interconnected and curved structure with no straight lines), Schwarz (a primitive and diamond-like TPMS surfaces), and lidinoid (e.g., a complex variation used in advanced material designs). TPMS structures may be specifically configured for the fluid flow dynamics, e.g., low-pressure drop (due to the lack of sharp edges) makes them ideal for compact cooling systems. The interconnected channels within a gyroid structure allow for better convective cooling. However, TPMS structures can not be produced by conventional methods (e.g., skiving), while ECAM is capable of producing the TPMS structures for heat-exchanging applications (e.g., EV battery cooling, microprocessors, and heat exchangers)

In some examples, functional grading is used for different parts of a multi-phase heat exchanger (e.g., a condenser zone, evaporator zone, and adiabatic zone). For example, the lattice and/or structure density varies in a heat-exchanging portion 130 (such as from denser to more porous).

In some examples, a heat-exchanging portion 130 is formed by body-centered-cubic (BCC). A specific example of this type of heat-exchanging portion 130 is a composite body-centered-cubic (BCC). These types of heat-exchanging portion 130 have lattice structures that are optimized for “K/r”, with “K” being permeability, and “r” being effective pore radius. The “K/r” is a useful variable or parameter to understand the balance between the capillary pressure and permeability, i.e., how easily the fluid flows through something. These examples of a heat-exchanging portion 130 are suitable for wicking structures and 2-phase cooling.

### Examples of Methods for Fabricating Heat Exchangers

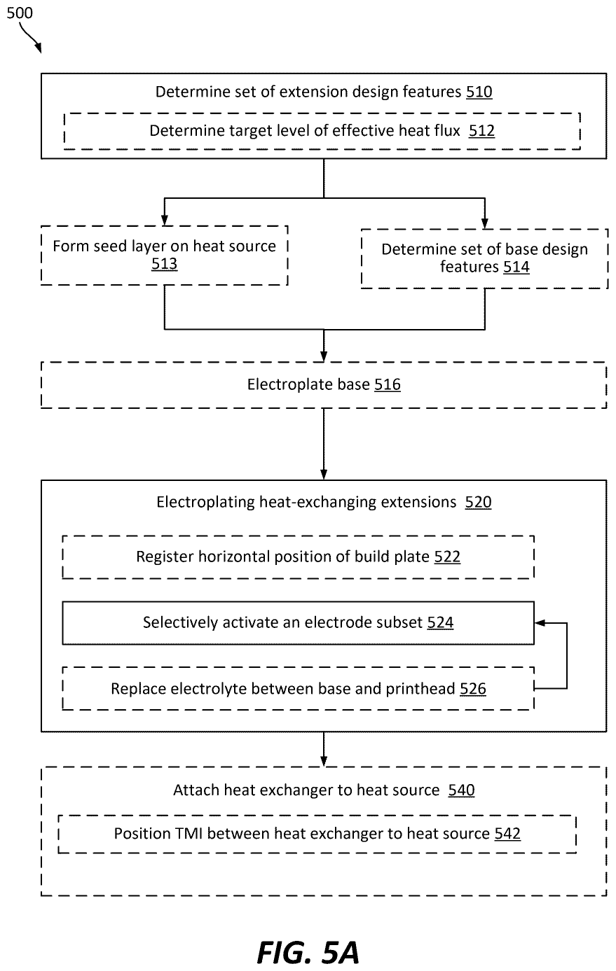

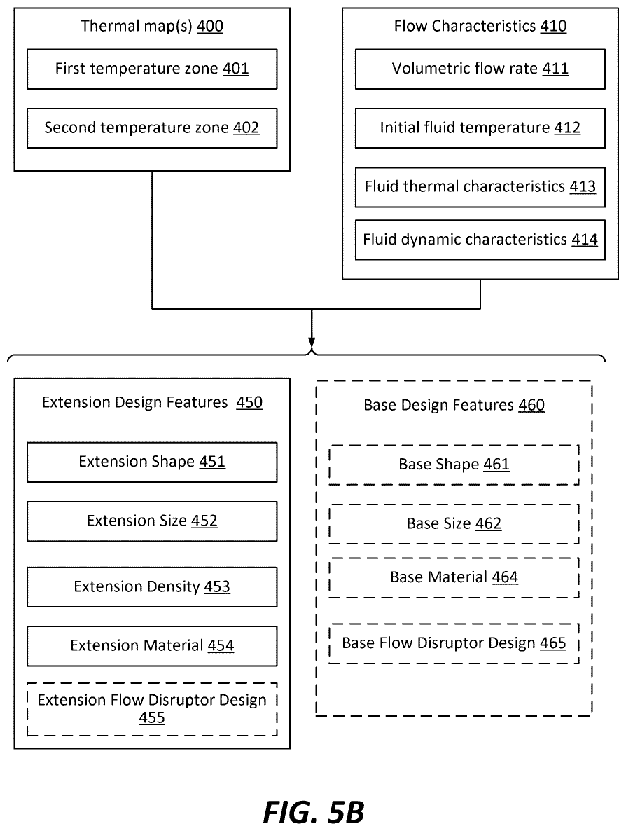

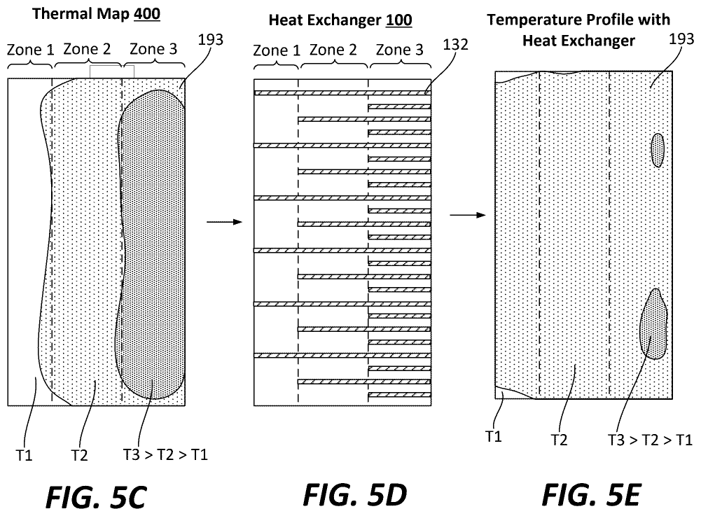

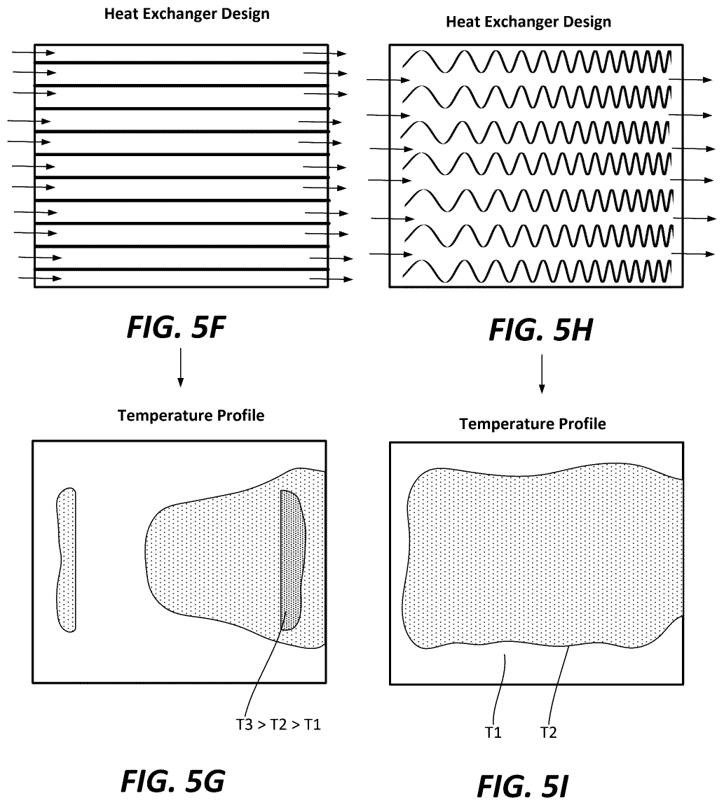

FIG. 5A is a process flowchart corresponding to a method 500 for fabricating a heat exchanger 100, in accordance with some examples. Various examples of heat exchangers 100 are described above. For example, a heat exchanger 100 may comprise a heat-receiving surface 101 for thermally coupling to a heat source 192. The heat exchanger 100 may further comprise heat-exchanging extensions 132 forming openings 122 for circulating a heat transfer fluid through the heat exchanger 100. Method 500 may be performed using an ECAM system 600 comprising a build plate 650 and a printhead 610. Various examples of ECAM systems 600 and corresponding processes are further described below.

Various aspects of this method 500 enable precise, localized electrochemical deposition, providing enhanced control over the geometry and material composition of the heat exchanger 100 or, more specifically, of the heat-exchanging portion 130, allowing for the fabrication of complex (e.g., nonlinear) geometries that are not possible with conventional methods such as skiving. FIG. 5B is a block diagram of various parameters used in the method of FIG. 5A that enables these features. For example, a thermal map 400 and/or flow characteristics 410 may be considered in determining the set of extension design features 450 and, when the base 110 is present, also the set of base design features 460.

In some examples, method 500 may commence with (block 510) determining a set of extension design features 450 of the heat-exchanging extensions 132. For example, this determining operation may be performed based on at least a thermal map 400 of the heat source 192. As noted above, the heat-exchanging extensions 132 are designed such that a unit-area thermal conductivity between the heat-receiving surface 101 and the heat transfer fluid is different for at least two different portions of the heat-receiving surface 101 during the operation of the heat exchanger 100. This unit-area thermal conductivity variation may be used to accommodate various “hot zones” of the heat source 192 or, more specifically, various “hot zones” of the heat-transferring surface 193. Furthermore, this unit-area thermal conductivity variation may be used to accommodate various characteristics associated with flowing the heat transfer fluid through the heat exchanger 100, e.g., changes in temperature (such as fluid heating), pressure drop, and/or phase change.

In some examples, (block 510) determining a set of extension design features 450 comprises (block 512) determining a target level of the unit-area thermal conductivity between the heat-receiving surface 101 and the heat transfer fluid for each unit area of the heat-receiving surface 101. In some examples, the unit-area thermal conductivity is the same across the entire heat-receiving surface 101. However, the set of extension design features 450 may need to accommodate changes in the heat transfer fluid (e.g., heating) as the heat transfer fluid flows through the heat exchanger 100 to maintain the same effective heat flux. Thereby, different parts (e.g., proximate to the heat exchanger inlet 102 and, separately, proximate to the heat exchanger outlet 103) of heat-exchanging extensions 132 may have different design features to accommodate these fluid changes. In further examples, the heat exchanger outlet 103 may have “hot spots” due to the design and operation of the heat exchanger inlet 102. These “hot spots” may require higher effective heat fluxes than other parts (operating at lower temperatures). As such, the design of heat-exchanging extensions 132 located at these “hot spots” may be different than the design of heat-exchanging extensions 132 located elsewhere. Overall, the set of extension design features 450 may vary for different parts of the heat-receiving surface 101.

Referring to FIG. 5B, in some examples, the thermal map 400 of the heat source 192 comprises a first temperature zone 401 and a second temperature zone 402 having a different temperature than the first temperature zone 401. For example, the first temperature zone 401 may represent a “hot spot”, while the second temperature zone 402 may represent a zone with a lower temperature. In more specific examples, the set of extension design features 450 corresponding to the first temperature zone 401 is different from the set of extension design features 450 corresponding to the second temperature zone 402.

FIG. 5C illustrates an example of a thermal map 400 with three temperature zones, such that T3>T2>T1. Specifically, this thermal map 400 represents the temperature profile of a heat-transferring surface 193 before thermally coupling this heat-transferring surface 193 to any heat exchanger (e.g., the heat-transferring surface 193 may be exposed to the environment—air at a room temperature and 50% humidity). FIG. 5D illustrates the design of a heat exchanger 100 determined/developed based on the thermal map 400 in FIG. 5C. Specifically, the heat-exchanging extensions 132 of this heat exchanger 100 have different densities in different locations (e.g., a higher density associated with the highest (T3) temperature zone). FIG. 5E illustrates a temperature profile of the same heat-transferring surface 193 after thermally coupling this heat-transferring surface 193 to the heat exchanger 100 in FIG. 5D. This temperature profile may be referred to as a “with-exchanger thermal map” and is a lot more uniform than the original thermal map 400.

FIGS. 5F-5I illustrate how different designs of heat exchangers 100 produce different “with-exchanger thermal maps”. The original (“before exchanger”) thermal map 400 is not presented. Specifically, FIG. 5F illustrates a heat exchanger with linear fins, and FIG. 5G illustrates a corresponding “with-exchanger thermal map”. FIG. 5H illustrates a heat exchanger with sinusoidal fins such that the oscillation frequency increases in higher temperature zones (T2 and even more so in T3). In some examples, the oscillation frequency may also vary (e.g., along the fluid path). Furthermore, different shapes of waves can be also used such as triangular, square, sawtooth, and the like. FIG. 5I illustrates a corresponding “with-exchanger thermal map”, which is more uniform than the thermal map in FIG. 5G. It should be noted that the number of fins in the FIG. 5H example is smaller than in the FIG. 5F example. However, the length of each fin is longer due to the sinusoidal shape. Overall, switching from a straight channel to a wavy channel may help with temperature uniformity.

In some examples, the set of extension design features 450 is further determined based on or more flow characteristics 410 of the heat transfer fluid. Some examples of these flow characteristics 410 include, but are not limited to, a volumetric flow rate 411, an initial fluid temperature 412, one or more fluid thermal characteristics 413, and one or more fluid dynamic characteristics 414. The volumetric flow rate 411 directly affects the total heat flux as it determines the amount of the heat transfer fluid passing through the heat exchanger 100 and available to receive the heat (i.e., the heat sinking capacity). Furthermore, the volumetric flow rate 411 determined the linear flow rates within the heat exchanger 100 with higher flow rates enhance convective heat transfer/turbulence (e.g., Reynolds number (Re)) and maintaining a higher temperature gradient (by being more rapidly replaced by new fluid). The initial fluid temperature 412 determines the driving force for heat exchange (ΔT), where larger temperature differences improve heat transfer rates. Furthermore, a combination of the initial fluid temperature 412, heat flux, and boiling temperature of the heat transfer fluid determines at which point the phase transfer may occur, which may be a design parameter or a condition that should be avoided. Fluid thermal characteristics 413, such as specific heat capacity (Cp), thermal conductivity (k), and density (p), dictate how much and how efficiently heat is absorbed and transferred. Finally, fluid dynamic characteristics 414, such as viscosity (u), impact flow regime (e.g., turbulence), and pressure losses.

In some examples, the set of extension design features 450 is selected from the group consisting of extension shape 451, extension size 452, extension density 453, extension material 454, and extension flow disruptor design 455. This extension design features 450 determine the thermal and hydrodynamic performance of a heat exchanger 100. For example, the extension shape 451, such as straight/flat, discreet/pin-shape, sinusoidal/wavy, or louvered, affects both surface area and fluid dynamics, with complex geometries like offset strip fins enhancing turbulence and disrupting laminar flow to improve convective heat transfer while also providing a greater surface area. Some aspects of the extension size 452 (e.g., height (H)) dictate the available surface area (of the heat-exchanging surfaces 133) for heat adsorption, while other aspects (e.g., thickness (T)) determine the heat dissipation pathways (e.g., from the heat-receiving surface 101 to the heat-exchanging surfaces 133). The extension density 453 may be defined as the number of heat-exchanging extensions 132 per unit area/width (depending on the type of heat-exchanging extensions 132) that impacts the trade-off between heat transfer enhancement and pressure drop. For example, a higher density improves thermal performance but can restrict flow, increasing energy losses. The extension material 454 determines thermal conductivity, with metals like copper and aluminum ensuring rapid heat spread from the base to the tip, minimizing thermal resistance. The extension material 454 determines thermal capacity, which may be used to accommodate rapid fluctuations in heat flux through the heat-receiving surface 101. Finally, the flow disruptor design 455, such as the presence/geometry of perforations, protrusions, edges, and the like introduces controlled turbulence to break up boundary layers, further boosting heat exchange (while also increasing the pressure losses).

In some examples, the build plate 650 is a part of the heat source 192 such that the heat-exchanging extensions 132 are electrochemically deposited on and attached to the heat source 192. In other words, at least a portion of the heat source 192 may be submerged into an electrolyte 680. In some examples, various sealing features may be used to protect various parts of the heat source 192, e.g., in a manner similar to a printhead 610. In these examples, method 500 may further comprise, prior to (block 520) electroplating the heat-exchanging extensions 132, (block 513) forming a seed layer on the heat source 192. For example, prior to forming the seed layer, the surface of the heat source 192 may not be sufficiently conductive (e.g., silicon). The seed layer may be formed from various conductive materials such as copper, tungsten, and the like. In some examples, a conductive seed layer has a thickness of less than 200 micrometers or even less than 100 micrometers. Forming the seed layer may involve one or more techniques selected from the group consisting of sputtering, electroless electroplating, and thermal bonding.

This example, in which the heat-exchanging extensions 132 are electrochemically deposited on and attached to the heat source 192, may be referred to as “direct to die”. The benefit of this example is that the heat transfer fluid may be brought in direct contact with the heat source 192, e.g., the heat-receiving surface 101 may be the same as the heat-transferring surface 193, thereby enhancing the heat transfer characteristics from the heat source 192 to the heat transfer fluid.

In some examples, the heat exchanger 100 further comprises a base 110 such that the base 110 comprises the heat-receiving surface 101 for thermal coupling to the heat source 192. For example, the build plate 650 is a part of the base 110 such that the heat-exchanging extensions 132 electrochemically deposited on and attached to the base 110. The base 110 may be fabricated in a separate process (e.g., machined). Alternatively, method 500 may further comprise, prior to (block 520) electroplating the heat-exchanging extensions 132, (block 516) electroplating the base 110 on the build plate 650 (e.g., in a manner similar to the “direct to die” example presented above).

For example, the base 110 may be electroplated using an ECAM system 600, e.g., the same ECAM system 600 that is used for electroplating the corresponding heat-exchanging extensions 132. In some examples, the process of electroplating the base 110 is continuous with electroplating the heat-exchanging extensions 132. With ECAM fabrication of the base 110, method 500 may further comprise, prior to (block 516) electroplating the base 110, (block 514) determining a set of base design features 460 based on at least a thermal map 400 of the heat source 192. Specifically, both the heat-exchanging extensions 132 and the base 110 are designed such that a unit-area thermal conductivity between the heat-receiving surface 101 and the heat transfer fluid is different for at least two different portions of the heat-receiving surface 101 during operation of the heat exchanger 100. In some examples, the set of base design features 460 is selected from the group consisting of base shape 461, base size 462, base material 464, and base flow disruptors 465. Some of these features are described above with reference to the set of extension design features 450.

When the base 110 is present, the heat-exchanging extensions 132 comprise heat-exchanging surfaces 133 extending to the base 110. A combination of the heat-exchanging surfaces 133 and the base 110 forms the openings 122 for circulating a heat transfer fluid through the heat exchanger 100. The openings 122 extend to the base 110 such that the heat transfer fluid directly interfaces the base 110 and the heat-exchanging surfaces 133 while circulating through the heat exchanger 100.

Method 500 may proceed with (block 520) electroplating the heat-exchanging extensions 132 on the build plate 650 in accordance with the set of extension design features 450. Specifically, and as further described below, the printhead 610 comprises a set of pixelated electrodes 620 and electrode-array drivers 616, each controlling current through a corresponding electrode in the set of pixelated electrodes 620 while electroplating the heat-exchanging extensions 132. This current control is based on the set of extension design features 450, e.g., it may determine the locations of the heat-exchanging extensions 132 on the build plate 650. For example, (block 520) electroplating the heat-exchanging extensions 132 may involve (block 524) selectively activating an electrode subset from the set of pixelated electrodes 620 using the electrode-array drivers 616 thereby generating an ionic flow through the electrolyte 680 between the electrode subset and a portion of the deposition surface aligned with the electrode subset thereby electrochemically depositing heat-exchanging extensions 132. As noted above, the ability to control individual electrodes enables precision in material deposition thereby allowing complex geometries of the heat-exchanging extensions 13

The electroplating operation (block 520) comprises submerging a build plate 650 comprising a deposition surface into an electrolyte 680. Various aspects of the electrolyte 680 (e.g., containing various metal ions used for fabricating a heat-exchanging portion 130) are described below. The build plate 650 comprises one or more components selected from the group consisting of a base 110 and a heat source 192. For example, the build plate 650 may comprise the base 110 such that the base 110 comprises a heat-receiving surface 101 for thermal coupling to the heat-transferring surface 193 and the deposition surface opposite of the heat-receiving surface 101.

Overall, the submersion of the build plate 650 into the electrolyte 680 creates the necessary environment for electrochemical deposition, e.g., providing ion exchange and material deposition while enabling precise control over the material composition at different locations on the deposition surface.

Referring to FIG. 5A, in some examples, (block 520) electroplating the heat-exchanging extensions 132 further comprises (block 522) registering the horizontal position of the build plate 650 relative to the printhead 610 using a mapping process and based on the shape of the build plate 650. Furthermore, in some examples, (block 520) electroplating the heat-exchanging extensions 132 further comprises (block 526) replacing the electrolyte 680 between the printhead 610 and build plate 650 or, more specifically, between the printhead 610 and a partially formed heat-exchanging portion 130. The electrolyte 680 may be replaced with a fresh electrolyte having the same composition (e.g., to remove gas bubbles, and replenish metal ions) or with an electrolyte having a different composition (e.g., having different metal ions).

In some examples, method 500 further comprises (block 540) attaching the heat exchanger 100 to the heat source 192 or, more specifically, thermally coupling the heat-receiving surface 101 of the heat exchanger 100 to the heat-transferring surface 193 of the heat source 192. For example, (block 540) attaching the heat exchanger 100 to the heat source 192 comprises (block 542) positioning a thermal interface material (TIM) between the heat-receiving surface 101 and the heat source 192. A TIM may be a thermal grease, thermal pad (e.g., silicone), thermal tape, thermal gel, thermal adhesive (e.g., silver epoxies, etc.), solders, etc. For example, a thermal paste/grease may not bond but remain in a semi-liquid or gel-like state. A thermal pad may be formed from a solid soft material that conforms to the surfaces when pressure is applied. A thermal pad may not create a permanent bond but may stick slightly due to surface adhesion. A liquid metal may form a stronger physical connection with the metals (especially copper and aluminum) through wetting and minor alloying effects (without creating true chemical bonds). Adhesive TIMs are specialized TIMs, such as thermal epoxies, that bond surfaces together permanently and are often used in industrial applications where a heatsink must stay attached without mechanical fasteners. In general, TIMs with high thermal conductivity and minimal thickness are desirable (to reduce the thermal resistance). However, various manufacturing constraints may impact the minimal possible thickness.

### ECAM System Examples

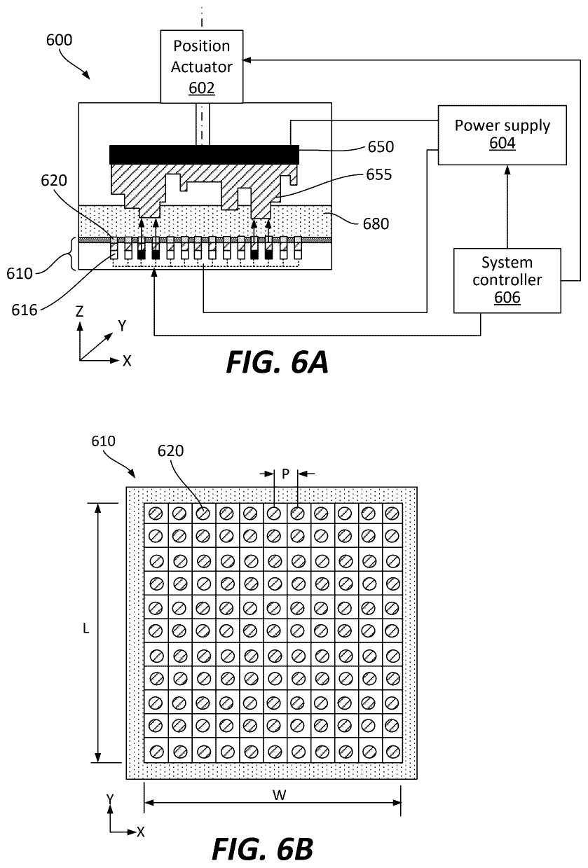

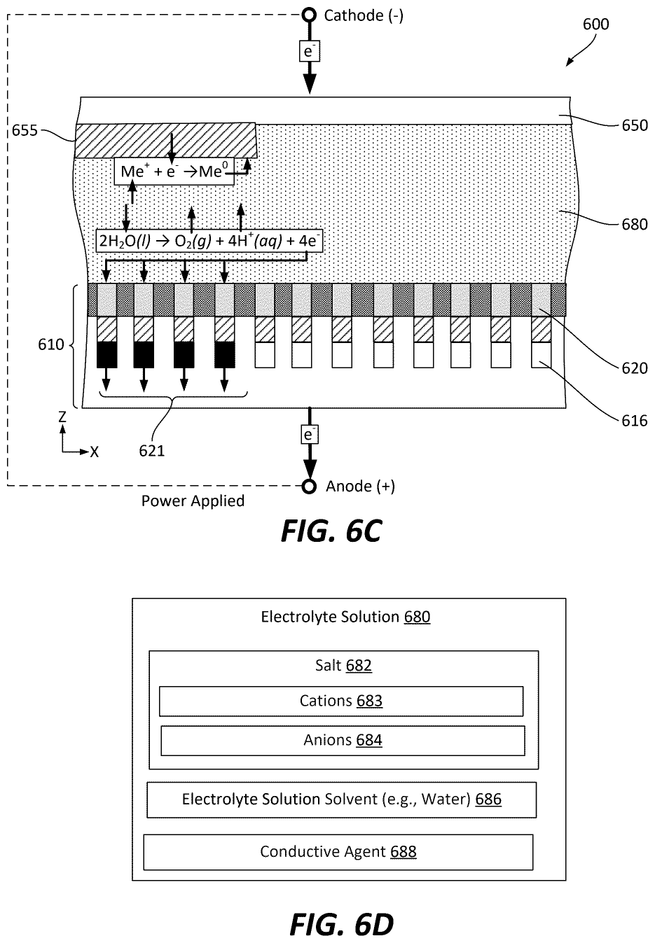

FIG. 6A is a schematic illustration of an ECAM system 600 used for depositing or, more specifically, electroplating material (e.g., copper deposit), in accordance with some examples. An ECAM system 600 may comprise a position actuator 602, a system controller 606, a deposition power supply 604, a printhead 610, and a build plate 650. In some examples, a build plate 650 is connected to the deposition power supply 604 and controllably supported relative to the ECAM printhead 610 (e.g., by position actuator 602).

An ECAM printhead 610 or simply a printhead 610 comprises a set of pixelated electrodes 620 and electrode-array drivers 616. Each of the electrode-array drivers 616 controls the current flow through a corresponding electrode in the set of pixelated electrodes 620 as well as the corresponding portion of the electrolyte 680 thereby causing the deposition on the corresponding surface of the material (e.g., copper deposit) on build plate 650.

A position actuator 602 can be mechanically coupled to the build plate 650 and used to change the positional relationship of the printhead 610 and build plate 650 (e.g., changing the gap between the printhead 610 and build plate 650 or, more specifically, the gap between the set of pixelated electrodes 620 and build plate 650, linearly moving and/or rotating one or both printhead 610 and build plate 650 within a plane parallel to the set of pixelated electrodes 620). While FIG. 6A illustrates the position actuator 602 coupled to the build plate 650, the position actuator may be coupled to the printhead 610 and/or the build plate 650. Other examples are also within the scope.

A system controller 606 is used for controlling the operations of various components. For example, FIG. 6A illustrates the system controller 606 that is communicatively coupled with the position actuator 602, deposition power supply 604, and electrode-array drivers 616. The system controller 606 can instruct the position actuator 602 to change the relative position of the printhead 610 and build plate 650. In the same or other examples, the system controller 606 can selectively instruct some electrode-array drivers 616 to provide current through a subset of pixelated electrodes 621 selected the set of pixelated electrodes 620 (e.g., based on the required deposition location).

During the operation, the ECAM system 600 also comprises electrolyte 680 comprising a source of cations (e.g., metal cations) that are reduced on build plate 650 (operable as a cathode during this operation) and form the material (e.g., copper deposit). More specifically, material (e.g., copper deposit) is deposited onto build plate 650 from the electrolyte 680 by flowing the electrical current between selected electrodes in the set of pixelated electrodes 620 and the build plate 650 as noted above. In some examples, further granularity is provided by controlling the current levels through each one of the electrode-array drivers 616. In other words, not only the current can be shut off through one or more electrode-array drivers 616 but different levels of current can flow through different electrode-array drivers 616 (and as a result through the corresponding electrodes in the set of pixelated electrodes 620).

Referring to FIG. 6B, a printhead 610 comprises a set of pixelated electrodes 620. These electrodes may be also referred to as microelectrodes (or micro-anodes), and/or pixels. This individually-addressable feature of the set of pixelated electrodes 620 allows the achievement of different deposition rates at different locations on build plate 650. The electrodes form a deposition grid, in which these electrodes may be offset relative to each other along the X-axis and Y-axis, each within a grid footprint. Rectangular grids may be characterized by a grid X-axis pitch (corresponding to the length of each grid zone along the X-axis), grid Y-axis pitch (corresponding to the length of a grid zone along the Y-axis), overall grid pitch (corresponding to the minimum of the grid X-axis pitch and the grid Y-axis pitch), and grid zone area. In the same or other examples, one or both of the grid's X-axis pitch and the Y-axis pitch are 600 micrometers or less, 50 micrometers or less, or even 35 micrometers or less. Other example grids include triangular, hexagonal, or other patterns that partially or completely tessellate a surface. In some examples, the electrodes are formed/deposited from an insoluble conductive material, such as platinum group metals and their associated oxides, doped semiconducting materials, and carbon nanotubes. The shape of the electrodes can be round, rectangular, or other shapes. The area of the electrodes (the pixel size) is smaller (e.g., at least 6% smaller, at least 60% smaller, at least 20% smaller) than the grid footprint, thereby providing space between the electrodes. In some examples, the pitch is between 25 micrometers and 35 micrometers, while the pixel size is between 65 micrometers and 20 micrometers.

FIG. 6C is a schematic expanded view of a portion of ECAM system 600 illustrating electrolyte 680 between the printhead 610 and build plate 650, in accordance with some examples. FIG. 6D is a schematic block diagram illustrating different components of electrolyte 680. For example, electrolyte 680 may comprise salt 682, electrolyte solution solvent 686, and conductive agent 688. Salt comprises cations 683 and anions 684. Cations 683 can be in the form of metal ions, metal complexes, and the like. Some examples of cations 683 include metal cations (e.g., copper ions, nickel ions, tungsten ions, gold ions, silver ions, cobalt ions, chrome ions, iron ions, or tin ions), and other types of cations are within the scope. Some specific examples of salt 682 (feedstock ion sources) include but are not limited to copper sulfate, copper chloride, copper fluoroborate, copper pyrophosphate, nickel sulfate, nickel ammonium sulfate, nickel chloride, nickel fluoroborate, zinc sulfate, sodium thiocyanate, zinc chloride, ammonium chloride, sodium tungstate, cobalt chloride, cobalt sulfate, hydroxy acids, and aqua ammonia. In some examples, feedstock ion sources, or other sources of cations (e.g., salts) are referred to as material concentrates. Electrolyte solution solvent 686 can be water, which dissociates (2H2O(I)=>O2(g)+4H+ (aq.)+4e−) on the electrodes that are activated during this operation. Specifically, the activated electrodes are connected to the deposition power supply. In some examples, electrolyte 680 comprises catholyte conductive agent 688, such as an acid (e.g., sulfuric acid, acetic acid, hydrochloric acid, nitric acid, hydrofluoric acid, boric acid, citric acid, and phosphoric acid). In some examples, electrolyte 680 comprises one or more additives, such as a leveler, a suppressor, and an accelerator, particulates for co-deposition (e.g., nanoparticles and microparticles such as diamond particles, tungsten-carbide particles, chromium-carbide particles, and silicon-carbide particles).

Returning to the example shown in FIG. 6D, cations (e.g., metal cations are combined with electrons, which are supplied to build plate 650 thereby forming the material (e.g., copper deposit). As noted above, the charge balance within electrolyte 680 is maintained by protons generated at the printhead 610. It should be noted that only a set of activated electrodes (illustrated in black color) can be activated during this ECAM process resulting in electrolytic deposit/material formed on a corresponding portion of build plate 650. This corresponding portion is aligned with the activated electrode while the remaining portion of electrodes (inactive electrodes) remains free of electrolytic deposit. This selective deposition is a core ECAM feature provided by selective control of the current passing through the activated electrodes.

Specifically, in some examples, an ECAM system 600 comprises a build plate 650 and a printhead 610 comprising a set of pixelated electrodes 620 and electrode-array drivers 616, such that each of the electrode-array drivers 616 is configured to control a current flow through a corresponding electrode in the set of pixelated electrodes 620. The ECAM system 600 also comprises a position actuator 602 for controlling the position of the build plate 650 relative to the printhead 610 and a power supply 604 connected to the build plate 650 and each of the electrode-array drivers 616. Furthermore, the ECAM system 600 comprises a system controller 606 communicatively coupled to each of the electrode-array drivers 616, the position actuator 602, and the power supply 604. The system controller 606 is configured to store various deposition parameters, e.g., which are developed based on the configuration of the heat exchanger 100. During this operation, a subset of pixelated electrodes 621 is selectively activated from the set of pixelated electrodes 620 according to the deposition parameters thereby causing an ionic flow through an electrolyte 680 provided between at least the subset of pixelated electrodes 621 and the printhead 610. Furthermore, the system controller 606 is configured to (c) instruct the power supply 604 and the electrode-array drivers 616 to map the deposited layer 655 by applying a mapping voltage to each pixelated electrode in the subset of pixelated electrodes 621 and monitoring a current through each pixelated electrode in the subset of pixelated electrodes 621. In some examples, such a mapping process may be used to register the horizontal (left, right) position of the build plate 650 relative to the printhead 610 based on the shape and/or features of the build plate 650. As noted elsewhere, the current through each pixelated electrode in the subset of pixelated electrodes 621 depends on a vertical positional relationship (e.g., the gap) between each pixelated electrode in the subset of pixelated electrodes 621 and the deposited layer 655.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A method of fabricating a heat exchanger using an ECAM system comprising a build plate and a printhead, the heat exchanger comprising a heat-receiving surface for thermal coupling to a heat source, the heat exchanger further comprising heat-exchanging extensions forming openings for circulating a heat transfer fluid through the heat exchanger, the method comprising:
determining a set of extension design features of the heat-exchanging extensions based on at least a thermal map of the heat source, wherein the heat-exchanging extensions are designed such that a unit-volume material to space ratio between the heat-exchanging extensions and the openings is different for at least two different portions of the heat-receiving surface during operation of the heat exchanger; and
electroplating the heat-exchanging extensions on the build plate in accordance with the set of extension design features, wherein:
the printhead comprises a set of pixelated electrodes and electrode-array drivers, each controlling current through a corresponding electrode in the set of pixelated electrodes while electroplating the heat-exchanging extensions, and
controlling the current determines locations of the heat-exchanging extensions on the build plate.

2. The method of claim 1, wherein determining a set of extension design features comprises determining a target level of the unit-volume material to space ratio between the heat-exchanging extensions and the openings.

3. The method of claim 2, wherein the set of extension design features varies for different parts of the heat-receiving surface.

4. The method of claim 1, wherein the thermal map of the heat source comprises a first temperature zone and a second temperature zone having a different temperature than the first temperature zone.

5. The method of claim 4, wherein the set of extension design features corresponding to the first temperature zone is different from the set of extension design features corresponding to the second temperature zone.

6. The method of claim 1, wherein the set of extension design features is further determined based on or more flow characteristics of the heat transfer fluid selected from the group consisting of a volumetric flow rate, an initial fluid temperature, one or more fluid thermal characteristics, and one or more fluid dynamic characteristics.

7. The method of claim 1, wherein the set of extension design features is selected from the group consisting of extension shape, extension size, extension density, extension material, and extension flow disruptor design.

8. The method of claim 1, wherein the build plate is a part of the heat source such that the heat-exchanging extensions are electrochemically deposited on and attached to the heat source.

9. The method of claim 1, further comprising, prior to electroplating the heat-exchanging extensions, forming a seed layer on the heat source.

10. The method of claim 1, wherein:
the heat exchanger further comprises a base comprising a heat-receiving surface for thermal coupling to the heat source; and
the build plate is a part of the base such that the heat-exchanging extensions are electrochemically deposited on and attached to the base.

11. The method of claim 10, further comprising, prior to electroplating the heat-exchanging extensions, electroplating the base on the build plate.

12. The method of claim 11, further comprising, prior to electroplating the base, determining a set of base design features based on at least a thermal map of the heat source.

13. The method of claim 12, wherein the set of base design features is selected from the group consisting of base shape, base size, base material, and base flow disruptors.

14. The method of claim 10, wherein:
the heat-exchanging extensions comprise heat-exchanging surfaces extending to the base,
a combination of the heat-exchanging surfaces and the base forms the openings for circulating a heat transfer fluid through the heat exchanger, and
the openings extend to the base such that the heat transfer fluid directly interfaces the base and the heat-exchanging surfaces while circulating through the heat exchanger.

15. The method of claim 1, further comprising attaching the heat exchanger to the heat source.

16. The method of claim 1, wherein attaching the heat exchanger to the heat source comprises positioning a thermal interface materials (TIM) between the heat-receiving surface and the heat source.

17. The method of claim 1, wherein the heat source is selected from the group consisting of a central processing unit (CPU), a graphical processing unit (GPU), an application-specific integrated circuit (ASIC), a field-programmable gate array (FPGA), a chipset, a power amplifier, a memory module, and a power management integrated circuit (IC).

18. The method of claim 1, wherein the heat-exchanging surfaces of the heat-exchanging extensions have a height (H) that is different at different parts of the heat-receiving surface.

19. The method of claim 18, wherein:
the heat exchanger comprises a heat exchanger inlet and a heat exchanger outlet,
the heat exchanger inlet is configured to receive the heat transfer fluid into the heat exchanger,
the heat exchanger outlet is configured to discharge the heat transfer fluid from the heat exchanger, and
the height (H) increases along a pathway of the heat transfer fluid from the heat exchanger inlet to the heat exchanger outlet.

20. The method of claim 1, wherein:
the heat-exchanging extensions are continuous fins having a thickness (T) defined by the heat-exchanging surfaces and two adjacent ones of the openings,
the thickness (T) is different at different parts of the heat-receiving surface.
